(19) United States
(12) Patent Application Publication
(10) Pub. No.: US 2013/0061710 A1
(43) Pub. Date: Mar. 14, 2013

(54) BALL JOINT MECHANISM, KINEMATIC CHAIN AND PARALLEL ROBOT

(71) Applicant: Bo LONG, Shenzhen City (CN)

(72) Inventor: Bo LONG, Shenzhen City (CN)

(73) Assignees: Hon Hai Precision Industry Co., Ltd., Tu-Cheng (TW); Hong Fu Jin Precision Industry (ShenZhen) CO., LTD, Shenzhen City (CN)

(21) Appl. No.: 13/467,891

(22) Filed: May 9, 2012

(30) Foreign Application Priority Data
Sep. 8, 2011 (CN) 201110265557.4

(51) Int. Cl. B25J 17/00; F16C 11/06

(52) U.S. Cl. 74/490.05; 403/132; 901/28; 901/15

(57) ABSTRACT

A ball joint mechanism includes a ball joint member, a ball socket member and a plurality of elastic assemblies. The ball joint member has a head portion. The ball socket member defines a spherical engaging socket and a plurality of mounting holes communicating with the spherical engaging socket. The head portion of the ball joint member is assembled into and pivotally engages with the corresponding spherical engaging socket of the ball socket member. The plurality of elastic assemblies are assembled within the mounting holes of the ball socket member, respectively, and elastically resist against a periphery of the ball joint member. One or more kinematic chains and a parallel robot using the ball joint mechanism are also provided.

### BACKGROUND

1. Technical Field

The present disclosure relates generally to joint mechanisms, particularly, to a ball joint mechanism, a kinematic chain and a parallel robot using the ball joint mechanism.

2. Description of Related Art

A parallel robot is extensively used in flight simulation and wave simulation. Many parallel robots include a fixed platform, a moveable platform, and six kinematic chains positioned in parallel between the fixed platform and the moveable platform. The six kinematic chains can provide a fore and aft motion, with each kinematic chain including a prismatic joint and two ball joints connected to the fixed platform and the moveable platform respectively. Under a combined synergy in movement of the six kinematic chains, the moveable platform can be moved in six degrees of freedom relative to the fixed platform.

However, a ball head and a socket are always connected via the ball joint. A gap always exists between the ball head and the socket because of insufficient machining and/or low assembling precision. The ball head and the socket are easily abraded, and a vibration of the moveable platform occurs. Thus, a movement stability and a location precision of the parallel robot is decreased, making the parallel robot unsuitable for high precision applications.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of a parallel robot.

FIG. 2 is an isometric view of a ball joint mechanism of the parallel robot of FIG. 1.

FIG. 3 is an exploded, isometric view of the ball joint mechanism of FIG. 2.

FIG. 4 is a cross-sectional view of the ball joint mechanism of FIG. 2, taken along line IV -IV.

### DETAILED DESCRIPTION

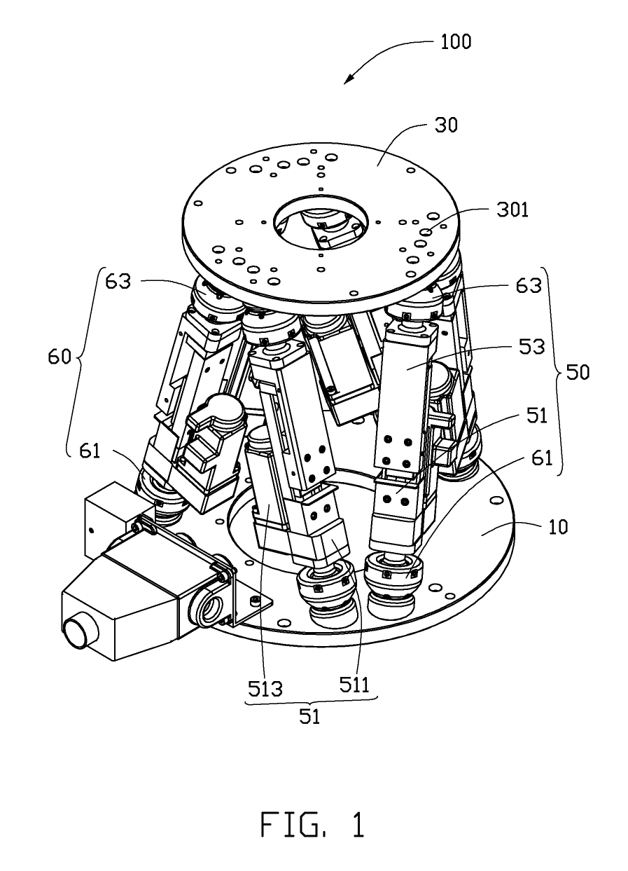

FIG. 1 shows one embodiment of a parallel robot 100 including a fixed platform 10, a moveable platform 30, and a plurality of kinematic chains 50 positioned in a particular configuration between the fixed platform 10 and the moveable platform 30. In the illustrated embodiment, there are six kinematic chains 50. Two ends of each kinematic chain 50 are connected to the fixed platform 10 and the moveable platform 30, respectively.

The fixed platform 10 and the moveable platform 30 are both substantially circular disk-shaped. A plurality of mounting holes 301 are defined in a periphery of the moveable platform 30 and the fixed platform 10.

Each kinematic chain 50 includes a first connecting member 51, a second connecting member 53, and two ball joint mechanisms 60. In the illustrated embodiment of FIG. 1, the two ball joint mechanisms 60 are a first ball joint mechanism 61 and a second ball joint mechanism 63. The first connecting member 51 and the second connecting member 53 are coaxially and retractably connected together. The two ball joint mechanisms 60, namely, the first ball joint mechanism 61 and the second ball joint mechanism 63, are oppositely mounted to two distal ends of the assembled first connecting member 51 and the second connecting member 53. Two ends of each kinematic chain 50 are assembled to the corresponding fixed platform 10 and the moveable platform 30, respectively, via the two ball joint mechanisms 60. The first connecting member 51 includes a connecting block 511 and a driver 513. The connecting block 513 is slidably and coaxially assembled with the second connecting member 53. The driver 513 is assembled on a side of the connecting block 511 for driving the second connecting member 53 to slide axially relative to the connecting block 511 thereby changing a total length of the kinematic chain 50. The driver 513 may be a hydraulic driver or a gas driver.

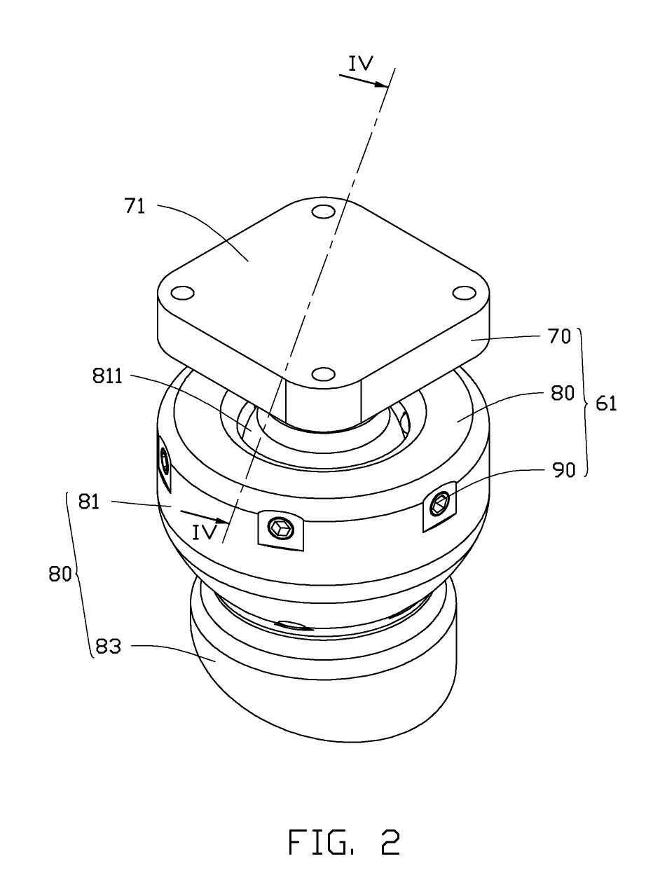

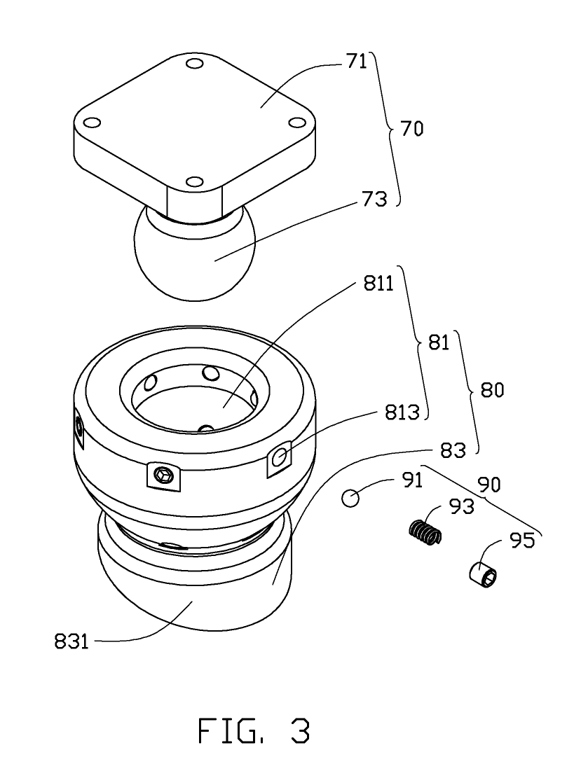

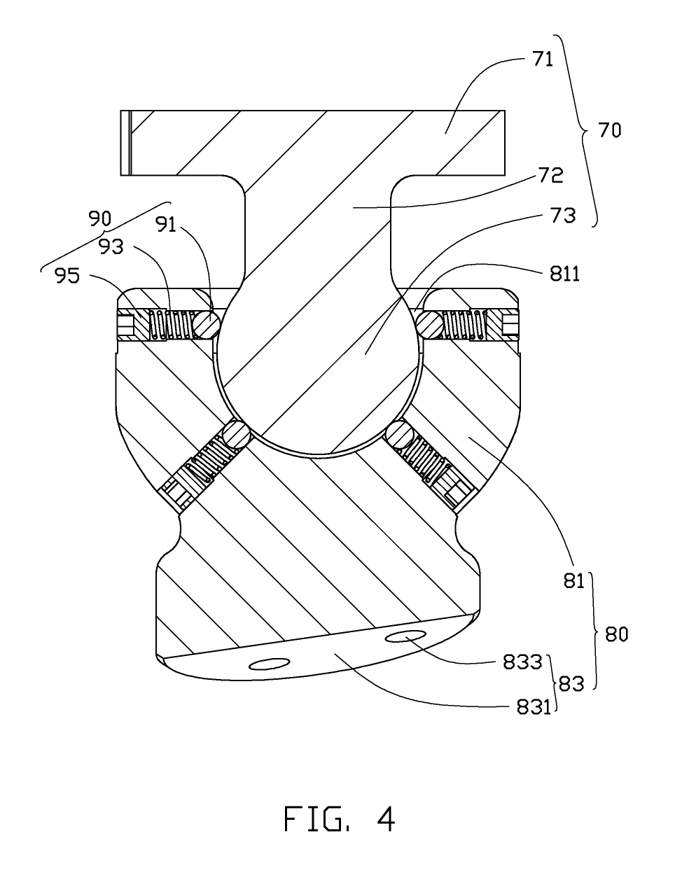

FIGS. 2 through 4, show that each ball joint mechanism 60 includes a ball joint member 70, a ball socket member 80, and a plurality of elastic assemblies 90. The ball joint member 70 is pivotally engaged with the ball socket member 80. The plurality of elastic assemblies 90 are separately assembled within the ball socket member 80 and elastically resist against the periphery of the ball joint member 70.

The ball joint member 70 includes a base body 71, a connecting portion 72 and a head portion 73. The base body 71 is substantially rectangular. The connecting portion 72 is substantially cylindrical and is formed on a substantially middle portion of one surface of the base body 71. The head portion 73 is substantially spherical and is formed on a distal end of the connecting portion 72, away from the base body 71.

The ball socket member 80 includes a base portion 81 and a fixing portion 83 formed on one end of the base portion 81. The base portion 81 defines a spherical engaging socket 811 recessed from a distal end surface thereof, away from the fixing portion 83, for pivotally engaging with the corresponding head portion 73 of the ball joint member 70. The base portion 81 further defines a plurality of mounting holes 813 through the peripheral surface thereof to communicate separately with the spherical engaging socket 811. The fixing portion 83 is substantially cylindrical and includes an inclined connecting end surface 831, away from the base portion 81, such that, when the fixing portion 83 of the ball socket member 80 is mounted to the fixed platform 10 or the moveable platform 30, the ball socket member 80 forms a slope angle with the fixed platform 10 or the moveable platform 30. The inclined connecting end surface 831 defines a plurality of fixing holes 833 for facilitating the fixing portion 83 being fixed to the fixed platform 10 or the moveable platform 30.

The plurality of elastic assemblies 90 are respectively assembled within the mounting holes 813 of the ball socket member 80, and elastically resist against the periphery of the ball joint member 70. Each elastic assembly 90 includes a resisting member 91, a locking member 95, and an elastic member 93. In the illustrated embodiment, the resisting member 91 is substantially spherical and is received within the mounting hole 813 of the ball socket member 80, and positioned adjacent to the spherical engaging socket 811 of the base portion 81 to elastically resist against the periphery of the head portion 73 via the elastic member 93. The locking member 95 is a hexagon socket set screw and is fixed within the mounting hole 813 of the ball socket member 80 and positioned away from the spherical engaging socket 811 of the base portion 81. The elastic member 93 is a helical spring assembled within the mounting hole 813 and is elastically sandwiched between the resisting member 91 and the locking member 95. In one embodiment, the locking member 95 may be omitted, such that, a first end of the elastic member 93 is directly fixed within the mounting hole 813 of the base portion 81, and a second end of the elastic member 93 opposite to the first end thereof resists against the resisting member 91.

When assembling the ball joint mechanism 60, the head portion 73 of the ball joint member 70 is aligned with and engaged into the corresponding spherical engaging socket 811 of the ball socket member 80, thus the ball joint member 70 and the ball socket member 80 are pivotally assembled together. The plurality of elastic assemblies 90 are respectively assembled into the mounting holes 813 of the ball socket member 80, the corresponding resisting member 91 of each elastic assembly 90 is positioned adjacent to the spherical engaging socket 811 end, and partially enters into the spherical engaging socket 811 to elastically resist against the periphery of the ball joint member 70 via the elastic member 93. When assembling the kinematic chain 50, the base bodies 71 of the two assembled ball joint mechanisms 60 are oppositely mounted to the opposite distal ends of the first connecting member 51 and the second connecting member 53, respectively. When assembling the parallel robot 100, the kinematic chains 50 are positioned in parallel between the fixed platform 10 and the moveable platform 30, the fixing portions 83 of two ends of the kinematic chains 50 are respectively connected to the fixed platform 10 and the moveable platform 30.

In use, the moveable platform 30 of the parallel robot 100 of the illustrated embodiment has six degrees of freedom relative to the fixed platform 10, under a combined synergy in movement of the six kinematic chains 50. The number of the kinematic chains 50 may be different according to the desired number of freedom of motion for the moveable platform 30. For example, the number of the kinematic chains 50 may be two to five. The ball joint member 70 maintains tight contact with the ball socket member 80 during use, depending on the elastic resisting force applied by the plurality of elastic assemblies 90. Even if a gap is produced during assembly or abrasion, such a gap between the ball joint member 70 and the ball socket member 80 is diminished or eliminated because of the elastic resisting force being applied. Thus, movement stability and location precision of the moveable platform 30 are thereby improved.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A ball joint mechanism, comprising:
a ball joint member having a head portion;
a ball socket member defining a spherical engaging socket and a plurality of mounting holes communicating with the spherical engaging socket; and
a plurality of elastic assemblies;
wherein, the head portion of the ball joint member is assembled into and pivotally engages with the corresponding spherical engaging socket of the ball socket member, the plurality of elastic assemblies are assembled within the mounting holes of the ball socket member, respectively, and elastically resist against a periphery of the ball joint member.

2. The ball joint mechanism of claim 1, wherein each elastic assembly comprises a resisting member and an elastic member, the resisting member is elastically assembled within the corresponding mounting hole of the ball socket member and resists against the periphery of the head portion of the ball joint member.

3. The ball joint mechanism of claim 2, wherein the resisting member is substantially spherical and partially received into the spherical engaging socket of the ball socket member to elastically resist against the head portion via the elastic member; the elastic member is a helical spring assembled within the mounting hole and elastically contacts with the resisting member.

4. The ball joint mechanism of claim 2, wherein the ball joint member further comprises a base body and a connecting portion formed on the base body, the head portion is formed on a distal end of the connecting portion, away from the base body; the ball socket member comprises a base portion and a fixing portion formed on the base portion, the spherical engaging socket is recessed from a distal end surface of the base portion, away from the fixing portion; the plurality of mounting holes are defined through a peripheral surface of the base portion to communicate with the spherical engaging socket, separately.

5. The ball joint mechanism of claim 4, wherein the fixing portion has an inclined connecting end surface, away from the base portion and defines a plurality of fixing holes in the inclined connecting end surface.

6. The ball joint mechanism of claim 3, wherein the elastic assembly further comprises a locking member, the locking member is fixed within the mounting hole of the ball socket member and positioned away from the spherical engaging socket of the base portion; the elastic member is elastically sandwiched between the resisting member and the locking member.

7. A kinematic chain, comprising:
a first connecting member;
a second connecting member coaxially and retractably assembled with the first connecting member; and
two ball joint mechanisms oppositely mounted to two distal ends of the first connecting member and the second connecting member, respectively; each ball joint mechanism comprising:
a ball joint member having a head portion;
a ball socket member defining a spherical engaging socket and a plurality of mounting holes communicating with the spherical engaging socket; and
a plurality of elastic assemblies;
wherein, the head portion of the ball joint member is assembled into and pivotally engages with the corresponding spherical engaging socket of the ball socket member, the plurality of elastic assemblies are assembled within the mounting holes of the ball socket member, respectively, and elastically resist against a periphery of the ball joint member.

8. The kinematic chain of claim 7, wherein each elastic assembly comprises a resisting member and an elastic member, the resisting member is elastically assembled within the corresponding mounting hole of the ball socket member and resists against the periphery of the head portion of the ball joint member; the first connecting member comprises a connecting block and a driver, the connecting block is slidably and coaxially assembled with the second connecting member, the driver is assembled aside of the connecting block for driving the second connecting member to slide relative to the connecting block axially.

9. The kinematic chain of claim 8, wherein the driver is a hydraulic driver or a gas driver; the resisting member is substantially spherical and partially received into the spherical engaging socket of the ball socket member to elastically resist against the head portion via the elastic member; the elastic member is a helical spring assembled within the mounting hole and elastically contacts with the resisting member.

10. The kinematic chain of claim 8, wherein the ball joint member further comprises a base body and a connecting portion formed on the base body, the head portion is formed on a distal end of the connecting portion, away from the base body; the ball socket member comprises a base portion and a fixing portion formed on the base portion, the spherical engaging socket is recessed from a distal end surface of the base portion, away from the fixing portion; the plurality of mounting holes are defined through a peripheral surface of the base portion to communicate with the spherical engaging socket, separately.

11. The kinematic chain of claim 10, wherein the fixing portion has an inclined connecting end surface, away from the base portion and defines a plurality of fixing holes in the inclined connecting end surface.

12. The kinematic chain of claim 9, wherein the elastic assembly further comprises a locking member, the locking member is fixed within the mounting hole of the ball socket member and positioned away from the spherical engaging socket of the base portion; the elastic member is elastically sandwiched between the resisting member and the locking member.

13. A parallel robot, comprising:
a fixed platform;
a moveable platform; and
a plurality of kinematic chains positioned between the fixed platform and the moveable platform, each kinematic chain comprising a first connecting member, a second connecting member coaxially and retractably connected to the first connecting member, and two ball joint mechanisms; the two ball joint mechanisms of each kinematic chain are oppositely mounted to two distal ends of the first connecting member and the second connecting member, and further assembled to the corresponding fixed platform and the moveable platform, respectively; each ball joint mechanism comprising:
a ball joint member having a head portion;
a ball socket member defining a spherical engaging socket and a plurality of mounting holes communicating with the spherical engaging socket; and
a plurality of elastic assemblies;
wherein, the head portion of the ball joint member is assembled into and pivotally engages with the corresponding spherical engaging socket of the ball socket member, the plurality of elastic assemblies are assembled within the mounting holes of the ball socket member, respectively, and elastically resist against a periphery of the ball joint member.

14. The parallel robot of claim 13, wherein each elastic assembly comprises a resisting member and an elastic member, the resisting member is elastically assembled within the corresponding mounting hole of the ball socket member and resists against the periphery of the head portion of the ball joint member; the first connecting member comprises a connecting block and a driver, the connecting block is slidably and coaxially assembled with the second connecting member, the driver is assembled aside of the connecting block for driving the second connecting member to slide relative to the connecting block axially.

15. The parallel robot of claim 14, wherein the driver is a hydraulic driver or a gas driver; the resisting member is substantially spherical and partially received into the spherical engaging socket of the ball socket member to elastically resist against the head portion via the elastic member; the elastic member is a helical spring assembled within the mounting hole and elastically contacts with the resisting member.

16. The parallel robot of claim 14, wherein the ball joint member further comprises a base body and a connecting portion formed on the base body, the head portion is formed on a distal end of the connecting portion, away from the base body; the ball socket member comprises a base portion and a fixing portion formed on the base portion, the spherical engaging socket is recessed from a distal end surface of the base portion, away from the fixing portion; the plurality of mounting holes are defined through a peripheral surface of the base portion to communicate with the spherical engaging socket, separately.

17. The parallel robot of claim 16, wherein the fixing portion has an inclined connecting end surface, away from the base portion and defines a plurality of fixing holes in the inclined connecting end surface.

18. The parallel robot of claim 15, wherein the elastic assembly further comprises a locking member, the locking member is fixed within the mounting hole of the ball socket member and positioned away from the spherical engaging socket of the base portion; the elastic member is elastically sandwiched between the resisting member and the locking member.
